(19) United States
(12) Patent Application Publication
(10) Pub. No.: US 2005/0076218 A1
(43) Pub. Date: Apr. 7, 2005

(54) Cryptographic electronic gift certificate cross-reference to related applications

(76) Inventor: Collie Brown, Mount Vernon, NY (US)

Correspondence Address: COLLIE D. BROWN, 206 NORTH COLUMBUS AVE, MOUNT VERNON, NY, 10552, US

(21) Appl. No.: 10/621,757

(22) Filed: Jul. 17, 2003

Related U.S. Application Data
(60) Provisional application No. 60/396,381, filed on Jul. 17, 2002.

(51) Int. Cl. H04L 9/00; G06F 17/60

(52) U.S. Cl. 713/175; 705/14; 705/67

(57) ABSTRACT

A software system that produces secure and easy to distribute electronic gift certificates. Electronic gift certificates that are electronically signed (18) using the certificate issuer's public and private electronic signature keys. The keys are based on Public Key Infrastructure algorithms such as Diffie-Hellman or RSA U.S. Pat. No. 4,405,829. Issuers of these certificates will have established relationships with vendors, entities who will exchange goods/services for the face value of the certificate. The issuer's public key, which is used to validate a certificate, is sent to vendors (35). When a certificate recipient presents the certificate to the vendor for redemption (43), the software uses the issuer's public key that was given to the vendor to validate the certificate (40). The vendor software submits the redeemed certificate to the issuer (44) so that the vendor can be reimbursed.

### CROSS-REFERENCE TO RELATED APPLICATIONS

Not applicable.

### BACKGROUND

1. Field of Invention

This invention relates to electronic gift certificates that is distributed over public and private computer networks.

2. Background of the Invention

In recent years there has been a large increase in electronic commerce over open networks such as the Internet; With so many websites offering similar products and services, it is becoming increasingly, more difficult for websites to distinguish themselves. One way to increase Internet customer and website visitor retention is to offer incentives. One such incentive involves the giving of electronic gift certificates. Many companies offer gift certificates that involve sending an email to the certificate recipient. This email usually contains the monetary value of the certificate and a password and optionally a serial number that the recipient must enter when redeeming the certificate at the certificate vendor website.

An example of how it currently works is explained by this example. If I wanted to offer one thousand dollars in electronic gift certificates to one hundred of my customers with each receiving a ten dollars certificate, I would go to a vendor such as Amazon.com and purchase the hundred gift certificates for a thousand dollars. Amazon would distribute the gift certificates to my customers. My customer is then able to go to Amazon's web site and redeem the certificate by entering the appropriate password and or Serial number. I would never know whether or not a certificate has been redeemed. Amazon would benefit from any unredeemed certificates since they were all previously paid for. The vendor (Amazon.com) is in full control of the process.

The electronic gift and rebate certificates of this invention differ from other gift and rebate certificates by allowing the issuing company to retain the savings from any unredeemed certificates. To accomplish this, the software of this invention is used to generate the certificates. The certificates of this invention are data that has been electronically signed. The electronic signing of the certificate data uses a public private key encryption algorithm. One such algorithm is described in U.S. Pat. No. 4,405,829 issued to Ronald Rivest, Adi Shamir, and Leonard Adleman. Other public key algorithms such as Diffie-Hellman Algorithm may also be used.

In Public/private key encryption algorithms, the public and private keys have opposite roles. The private key is used to encrypt data that can only be decrypted with its corresponding public key. The keys are generated together and neither key can be substituted or changed. The public key is usually distributed while the private key is not revealed.

Our software requires at least two sets of public private keys to generate certificates. The first set of public keys belongs to the data reviewer. The Reviewer must first review the information that will be used to generate the certificate such as the name of the receiver, the dollar amount, expiration dates, etc. Once the reviewer is satisfied with the accuracy of the information, the reviewer uses his or her private key to sign the data file. The file is then handed off to the Issuer. The Issuer is the person who uses his or her private key to generate the certificates. The public key of the Reviewer is installed on the Issuer's computer. The software uses the installed Reviewer's public key to verify that the reviewer signed the file and that the file was not altered after it was signed. The Issuer after reviewing the file to his or her satisfaction uses his or her private key to generate the electronic gift certificates. The certificates are then uploaded to a computer server for distribution. Included with each certificate is the Issuers public key.

The Issuers public key is also distributed to the vendors to be used by them to verify the authenticity of certificates presented to them for redemption. This includes verifying that the Issuer signed the certificate. The Issuer's public key is encrypted before distribution to prevent substitution. The encrypted public key is distributed separately from the password. The Issuer's public key is also installed on the computer server where vendors will send the certificates that have been redeemed for reimbursement. A vendor is reimbursed after the certificate is authenticated with the Issuer's public key.

The vendor checks a certificate by comparing the public key included in the certificate with that of the Issuers. If the public keys match the vendor uses the public key to decrypt the certificate. If the decrypted data is formatted correctly, the certificate is accepted. If encrypted data was modified or the public key was substituted the decrypted certificate output will not be formatted correctly and would contain extraneous data. The Issuers's computer server makes a similar check when the certificate is presented for reimbursement. Prior arrangements must be made with vendors for credit lines since vendors are supplying goods or services before payment is received.

Both the Reviewer and the Approver work for or on behalf of the certificate issuer.

To facilitate ease of use we have adopted XML as the preferred means of packaging the data elements of a certificate. We have also adopted the W3C (world wide web consortium) electronic signature specification as one means of packaging an electronic gift certificate. This specification is based on the public private key (PKI) encryption technology. We have added additional data elements to the electronic signature to accommodate the needs of a gift certificate. More information on W3C electronic signatures can be found at the web address http://www.w3.org/Signature/

### SUMMARY

It is an object of this invention to allow companies, individuals and other entities to generate and issue electronic gift certificates that can be redeemed at participating vendors websites or companies and if the certificate is not redeemed, retain the monies that would have otherwise gone to a vendor had the issuer purchased the certificates from a vendor.

Additionally, this invention enables electronic gift certificate issuers to issue electronic gift certificates that are redeemable at other companies' websites.

Additionally, this invention allows companies to participate in cross promotion of their business through the use of encrypted electronic gift certificate without the large risk involved with traditional password implemented electronic gift certificates where an unauthorized person could gain access to its password.

Objects and Advantages

Accordingly, beside the objects and advantages of the electronic gift certificate described in my above patent application description, several objects and advantages are
to provide a secure means for companies, individuals and institutions to generate and issue electronic gift certificates that are redeemable at vendors that do not require the use of passwords;

Provide a means to detect if a certificate has been altered using PKI-Public Private key encryption;
to provide the means where by the certificate issuer retains the value of all unredeemed electronic gift certificates instead of the vendor by requiring a certificate to be presented before the vendor is reimbursed;
to reduce the possibility of fraud by requiring both a reviewer and an Issuer to sign off on the content data that is used to generate electronic gift certificates;
to increase the ease of use by eliminating the need of the certificate recipient to memorize a password or serial number needed in traditional password certificates;
to provide a better means of controlling financial obligations resulting from the issuing of electronic gift certificates by including an expiration date that sets a specific exposure period;
to provide increased security by requiring the Reviewer and Issuer to change their public and private keys frequently thus reducing the chances that the keys used to generate the certificates will be compromised;
to provide a means whereby the software used to process the redeemed certificates is provided to the vendors at little or no cost there by reducing the time needed to integrate the processing of the electronic gift certificates and increasing the likelihood that the vendor will participate in the process;

Further objects and advantages are the reduced cost of implementing the system described in this invention, which consist primarily of installing software. Taking advantage of most existing computer networks including the Internet will further reduce the implementation cost. Further objects and advantages will become apparent from a consideration of the ensuing descriptions and drawings.

### DRAWINGS FIGURES

FIG. 1 shows the process of generating and distributing electronic gift certificates.

FIG. 2 shows how and to whom the public keys of the certificate data reviewer and the certificate data Issuer (certificate generator) are distributed.

FIG. 3 shows a customer redeeming an electronic gift certificate for goods and services and the vendor submitting the electronic gift certificate for reimbursement.

### REFERENCE NUMERALS IN DRAWINGS

10 The certificate data including name of recipient, value of certificate, expiration date etc, which will be used to later generate the certificates
12 The certificate data being reviewed before being electronically signed (encrypted with private key) by the reviewer
14 The reviewer signed certificate data being sent to the certificate data approval person
16 Software uses reviewer's public key to ensure file has not been altered after signing, upon Issuer's satisfaction of the accuracy of the certificate information the certificates are generated and signed using the Issuer's private key
18 Signed certificates are sent to issuer's server software for distribution
19 Certificates are emailed as an attachment to the customer (recipient)
20 Issuers server software distributes certificates as email file attachments or a link to the certificate on the web server software where customer can download certificate
22 Customer receives the certificate as an attachment or downloads the certificate using the link to the certificate in the email
24 Certificates are stored for later comparison before being reimbursed
30 Certificate data reviewer exports public key after generating it on their software
31 Reviewers public key encrypted with a password after exporting
32 Issuer enters password that is used to decrypt reviewers public key before importing it
33 Certificate data Issuer and certificate generator, exports public key after generating it on their software
34 Issuer's public key encrypted with a password is exported as a file
35 Issuers public key is imported onto the vendor's computer to be used to verify certificates that are redeemed
36 Issuers public key is imported onto the issuer's computer to be used to verify certificates that are presented for reimbursement
40 Vendor where customer will redeem electronic gift certificate
41 The vendor renders Goods or services
42 Customer having electronic gift certificate on his or her computer
43 Customer uploads electronic gift certificate file to vendor as payment
44 Vendor presents customers electronic gift certificate for reimbursement to certificate issuer
45 Certificate issuer verifies certificate with Issuer's public key and reimburses vendor.

### DETAILED DESCRIPTION OF THE PREFERRED EMBODIMENTS

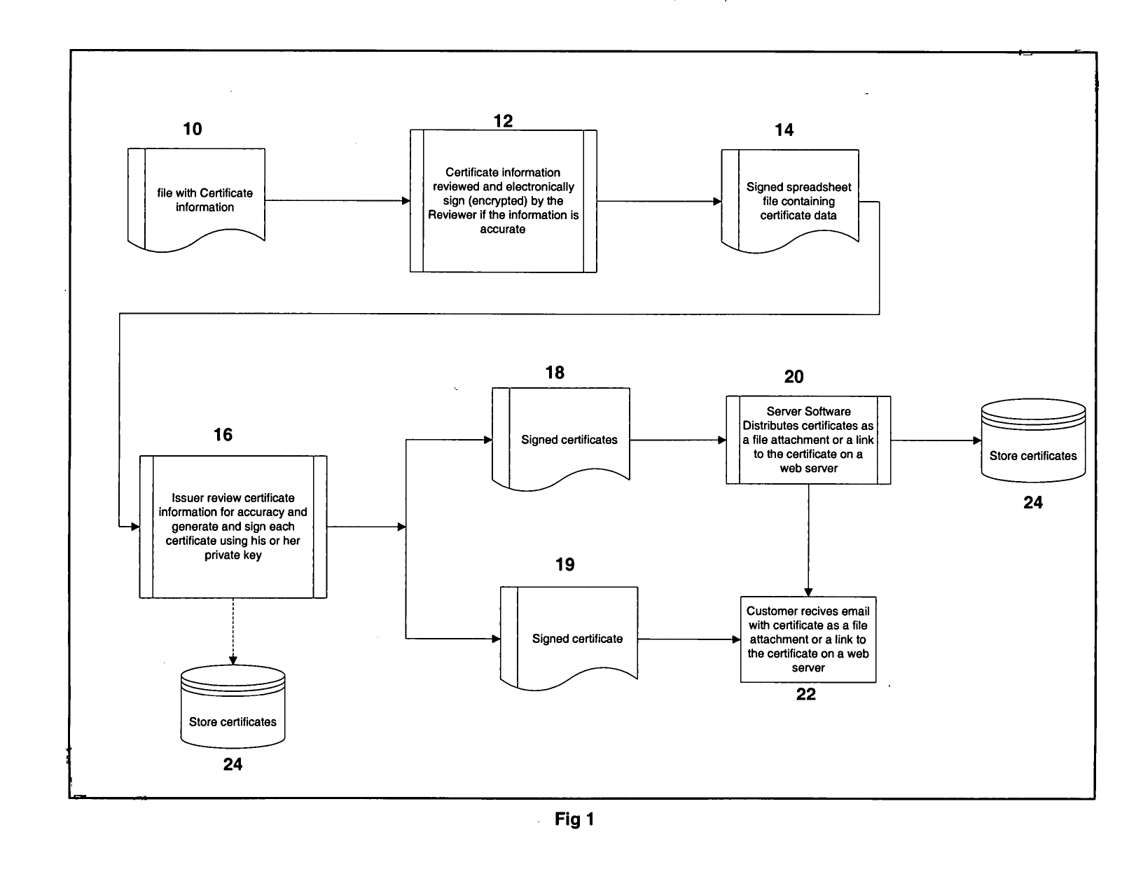

Referring now to FIG. 1 to FIG. 3, one embodiment of a decryption key management scheme for a software distribution system according to the present invention will be described in detail.

FIG. 1 shows the process of generating electronic gift certificates that are superior to password electronic gift certificates. A reviewer reviews the data that will be used as the basis of the certificates. Once the reviewer is satisfied with the accuracy of the information the reviewer electronically signs (encrypts the data using his or her private key) before sending it to the Issuer. The software the Issuer is using verifies the signed data using the public key of the reviewer before allowing the Issuer to generate and sign the certificates. If the Issuer is satisfied with the accuracy of the information the Issuer generates and sign the certificates using his or her private key. The certificates are then distributed by email or sent to a computer where the certificates are distributed.

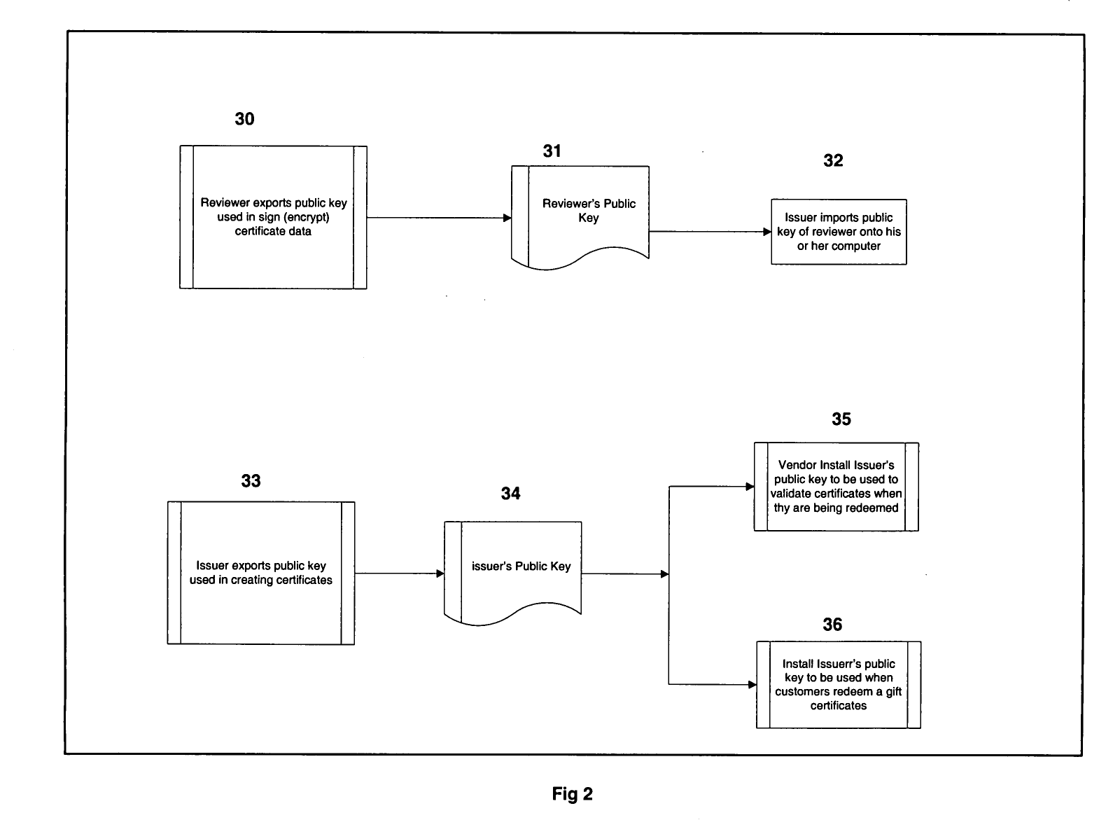

FIG. 2 shows how and to whom public keys are exported. The public key of the reviewer is exported in an encrypted file and sent to the Issuer. The encrypted public key file and the password used to decrypt it are sent by two different channels to reduce the security risk. The Issuer's public key is exported in an encrypted file and is installed on the vendor's and the issuers' computers.

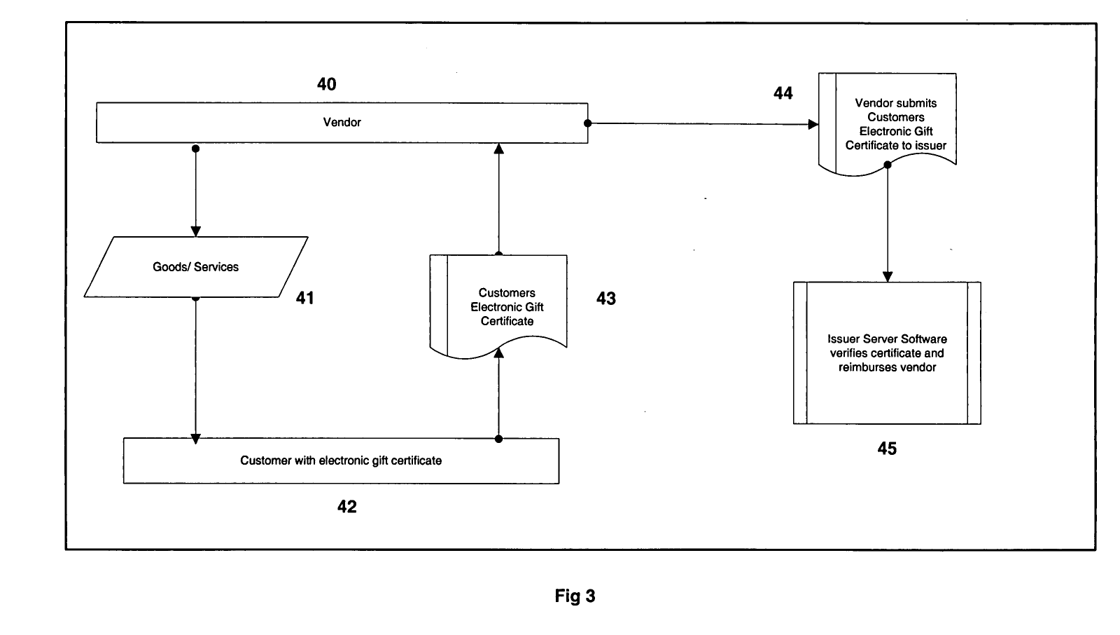

FIG. 3 shows a customer redeeming an electronic gift certificate for goods and services. The certificate is residing on the customer's computer in a electronically signed file. When the certificate is presented to the vendor, the vendor uses the public key of the Issuer to verify the integrity of the certificate. If the certificate has not been altered the certificate is presented to the issuer for reimbursement. If the issuer using the Issuer's public key verifies the certificate the vendor is reimbursed the value of the certificate.

Advantages

From the description above, a number of advantages of the electronic gift certificates become evident;

When implementing electronic incentive certificates it is more cost effective for the certificate issuer to manage the certificate issuance and distribution process instead of relying on vendors since unredeemed certificates do not cost the issuer any money whereas if the vendor issued the certificates the vendor would be the one reaping the benefits of any unredeemed certificates.

Electronic certificates that are created using public private keys are more secure than paper certificates which can be easily modified to reflect a higher value or longer expiration date.

Issuers can issue certificates that are redeemable at other vendors website or companies.

The posibility for fraud is reduced because a minimum of two individuals are required to review the file that is used to generate the certificate.

The certificate recipient does not have to remember passwords or serial numbers which makes these electronic incentive certificates easier to use than those requiring passwords.

Vendors can redeem a certificate without having to send it to the issuer for authentication.

Issuers can set up cross marketing opportunities with with vendors.

The software of this invention when used by the vendor has the ability to set limits on the amount of money the vendor is prepared to advance to the issuer over a specific period of time thereby limiting the financial exposure of the vendor.

The time to create and distribute certificates is much shorter than that required for paper certificates

The cost of producing and distributing the electronic certificates of this invention is less than the cost of producing and distributing similar value paper certificates because the distribution and redemption of the certificates of this invention is don by computers instead of the humans required by paper certificates.

Operation

Generating electronic gift certificates require two sets of public private encryption keys pairs to be created. One key pair belongs to the reviewer and the other to the certificate issuer. To electronically sign an electronic gift certificate the private key of issuer is to encrypt certificate data. To verify a certificate the corresponding public key is used to decrypt the certificate which is then checked for content and format. If the decrypted file is formatted correctly the verification passes.

First, someone working for the certificate Issuer prepares a file containing the names, email addresses, monetary value, expiration date, etc of each certificate. The file is then sent to a reviewer who reviews if for accureacy. If the file is accurate the reviewer uses his or private encryption key to electronically sign the file. The reviewer then sends the signed file to an Issuer who will also review the file for accuracy before generating and signing each electronic signature using his or her private key.

Before the Issuer is allowed to generate and sign each certificate, the Issuer's software uses the reviewer's matching public key that is installed on the Issuers computer to verify that the signed file has not been altered. After generating the certificates they are distributed electronically to the recipients.

The public key of the certificate generator/Issuer is distributed to vendors and is also installed on the issuers computer where vendors will present redeemed certificates for reimbursement. Before a certificate is reimbursed it is verified using the Issuer's public key. The vendors also uses the Issuers public key to verify that the certificate has not been altered before redeeming it.

Conclusion, Ramifications and Scope

Accordingly, the reader will see that our encrypted electronic gift certificate is more secure and economical to use that traditional password based electronic gift certificates. It has additional advantages in that

It does not require the installation of additional hardware so it can be used on most computer with not modifications necessary;

Encrypting each certificate significantly reduces the chance of it being altered;

It has built in expiration date allowing the issuer to control the lifespan of a certificate and thus control their financial exposure (obligation);

A multitude of different public private encryption algorithm can be used to implement the cryptographic functions such as RSA from RSA Security Inc;

Vendors can verify an electronic gift certificate that is being redeemed without contacting the issuer, allowing certificates to be redeemed even when no communication is possible with the issuer;

Certificate issuer retains savings when an issued certificate is not redeemed;

Certificate recipients do not have to memorize password or serial numbers making our electronic gift certificates easier to use than certificate implemented using passwords;

1. A method for creating electronic gift certificates involving at least one computer, is created from electronically signing data representing a monetary value, an expiration date, the name of the recipient, serial number, currency type or any other relevant data using a public private key encryption algorithm:

2. The method of claim 1 wherein said encryption algorithm is based on the public key infrastructure (PKI) standard including such algorithms as RSA public key encryption from RSA Security Inc.

3. The method of claim 1 wherein said data is sent to a reviewer as an electronic file or data stream or any other convenient means of packaging data, to be reviewed for accuracy after which said reviewer having determined the information to be accurate uses reviewers own private key, electronically sign said data.

4. The method of claim 3 wherein said signed data is sent to the Issuer where said data is again reviewed for accuracy before said Issuer using his or her private key generates and electronically signs or encrypts each electronic gift certificates.

5. The method of claim 4 wherein said reviewer or Issuer may include a person or computerized system.

6. The method of claim 4 wherein said certificates are distributed to recipients by various means including as an attachment in an email, downloaded form a web server or downloaded from a web server using a link in an email to locate the certificate.

7. The method of claim 6 wherein said recipients present said certificates electronically to designated vendors as payment for goods or services.

8. The method of claim 7 where said vendors use the public key of said certificate Issuer, verifies the authenticity of said certificates before providing goods or service.

9. The method of claim 8 wherein said vendors certificate verification includes checking the content and format of the decrypted output of said electronic gift certificate after decrypting it with the issuers public key.

10. The method of claim 9 wherein certificates passing said verification is redeemed before being submitted to the certificate issuer for reimbursement.

11. The method of claim 10 wherein said issuer will reimburse said vendors only if said certificate passes verification using the Issuers public key.

12. The method of claim 4 wherein said issuer using the public key of said reviewer verify that the data was signed by said reviewer and has not been altered, before said issuer is allowed to generate any electronic gift certificates.

13. The method of claim 1 wherein said electronic gift certificates utilizes the world wide web consortium (W3C) organization electronic signature XML specification as one means of encapsulating the electronic gift certificate.

14. The method of claim 13 wherein said XML specification is modified sufficiently to accommodate the additional data elements needed in an electronic gift certificate.

15. The method of claim 4 wherein the public key of said Issuer is distributed by secure means including encrypting said public key with a password, to relevant parties including vendors or computer systems, thereby providing said parties the ability to verify electronic gift certificates issued by said Issuer.

16. The method of claim 1 wherein savings from any unredeemed or expired gift certificates are retained by the certificate issuer.

17. The method of claim 4 whereby the certificate issuer establishes sufficient credit with vendors where certificates will be redeemed to cover the cost of redeemed certificates before the vendors are reimbursed.

18. The method of claim 5 wherein said certificate issuers and said reviewer may have their responsibilities combined thereby requiring the use of one set of public private key pair.

19. The method of claim 1 wherein said certificate may be used as an electronic rebate check.

20. The method of claim 4 wherein said certificate may include a password whereby software can be used to force the certificate recipient to enter said password before said certificate can be presented to any vendor for redemption.
